(19) United States
(12) Patent Application Publication
(10) Pub. No.: US 2019/0384868 A1
(43) Pub. Date: Dec. 19, 2019

(54) METHOD AND APPARATUS FOR ADAPTIVE VOLTAGE SCALING TO ELIMINATE DELAY VARIATION OF WHOLE DESIGN

(71) Applicant: Realtek Semiconductor Corp., HsinChu (TW)

(72) Inventors: Mei-Li Yu, Hsinchu City (TW); Ying-Chieh Chen, Keelung City (TW); Yu-Lan Lo, Hsinchu County (TW); Hsin-Chang Lin, Hsinchu County (TW); Shu-Yi Kao, Hsinchu County (TW)

(21) Appl. No.: 16/355,837

(22) Filed: Mar. 17, 2019

(30) Foreign Application Priority Data
Jun. 13, 2018 (TW) 107120275

(51) Int. Cl. G06F 17/50

(52) U.S. Cl. CPC G06F 17/505; G06F 17/5054; G06F 17/5031; G06F 17/5013; G06F 17/5059

(57) ABSTRACT

A method and apparatus for adaptive voltage scaling to eliminate delay variation of a whole design are provided. The method may include: reading a circuit simulation netlist file, a circuit design database, and a path list; building a delay variation database of each minimum unit within multiple minimum units of the whole design under various voltage levels according to the circuit design database; utilizing an initial voltage level to be a voltage level of a driving voltage of the whole design to apply the initial voltage level to the whole design, and performing static timing analysis (STA) on the whole design, to determine whether any timing violation path exists in the path list; and selectively adjusting the voltage level of the driving voltage and re-performing the STA until no timing violation path exists.

### BACKGROUND OF THE INVENTION

### 1. Field of the Invention

The present invention is related to adaptive voltage scaling, and more particularly, to a method and apparatus for adaptive voltage scaling to eliminate delay variation of a whole design.

### 2. Description of the Prior Art

Regarding the development of semiconductor process technology in recent years, process variation information provided by wafer fab may help system development engineers to perform system design having high yield. However, component types, component sizes and operating voltage used for different blocks within the system design may be different according to respective design consideration. In addition, when global variation and local variation are considered together, conventional corner variation method cannot precisely determine the variation in the system design, for example, it may be too optimistic or too pessimistic. As a result, it is hard to improve the yield, and therefore additional costs may be introduced. Thus, a novel method is needed to precisely estimate the variation of the system design, in order to eliminate delay variation of the system design without introducing any side effect or in a way that is less likely to introduce a side effect.

### SUMMARY OF THE INVENTION

An objective of the present invention is to provide a method for adaptive voltage scaling to eliminate delay variation of a whole design and associated analyzing device, to solve the aforementioned problems.

Another objective of the present invention is to provide a method for adaptive voltage scaling to eliminate delay variation of a whole design and associated analyzing device, to eliminate the delay variation of the system design without introducing any side effect or in a way that is less likely to introduce a side effect.

At least one embodiment of the present invention provides a method for adaptive voltage scaling to eliminate delay variation of a whole design. The method comprises: reading a circuit simulation netlist file, a circuit design database, and a path list, wherein the circuit simulation netlist file indicates component information of the whole design; according to the circuit design database, building a delay variation database of each minimum unit within multiple minimum units of the whole design under various voltage levels; utilizing an initial voltage level to be a voltage level of a driving voltage of the whole design to apply the initial voltage level to the whole design, and according to the delay variation database, performing static timing analysis (STA) on the whole design, to determine whether any timing violation path exists in the path list; and according to whether the timing violation path exists, selectively adjusting the voltage level of the driving voltage and re-performing the STA until no timing violation path exists.

At least one embodiment of the present invention provides an analyzing device. The analyzing device may comprise a processing circuit. The analyzing device is arranged to control the analyzing device to perform the following operations: reading a circuit simulation netlist file, a circuit design database, and a path list, wherein the circuit simulation netlist file indicates component information of the whole design; according to the circuit design database, building a delay variation database of each minimum unit within multiple minimum units of the whole design under various voltage levels; utilizing an initial voltage level to be a voltage level of a driving voltage of the whole design to apply the initial voltage level to the whole design, and according to the delay variation database, performing static timing analysis (STA) on the whole design, to determine whether any timing violation path exists in the path list; and according to whether the timing violation path exists, selectively adjusting the voltage level of the driving voltage and re-performing the STA until no timing violation path exists.

One of advantages of the present invention is that the present invention can perform analysis having high precision for delay variation of the whole design, and find an adaptive voltage level to eliminate the delay variation to improve yield. In addition, implementing according to the embodiments of the present invention will not greatly increase additional costs. Therefore, problems of the related art can be solved without greatly increasing the overall cost. In comparison with the related art, the present invention can precisely analyze delay variation of the whole design, and eliminate the delay variation of system design to improve yield without introducing side effects or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a whole design and a voltage supply circuit according to an embodiment of the present invention.

FIG. 2 is a diagram illustrating a whole design and the voltage supply circuit according to another embodiment of the present invention.

FIG. 3 is a workflow of the method according to an embodiment of the present invention.

FIG. 4 is a diagram illustrating an analyzing device according to an embodiment of the present invention.

### DETAILED DESCRIPTION

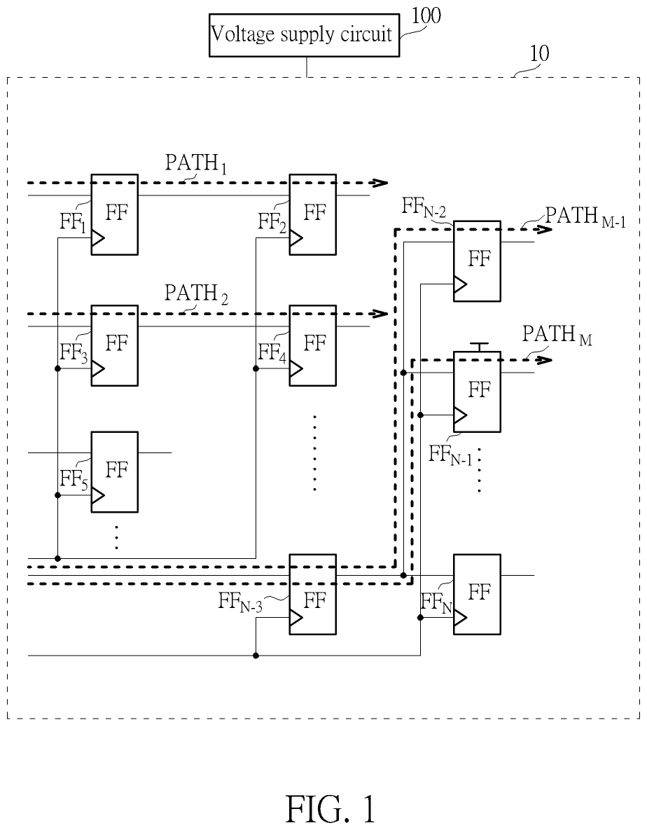

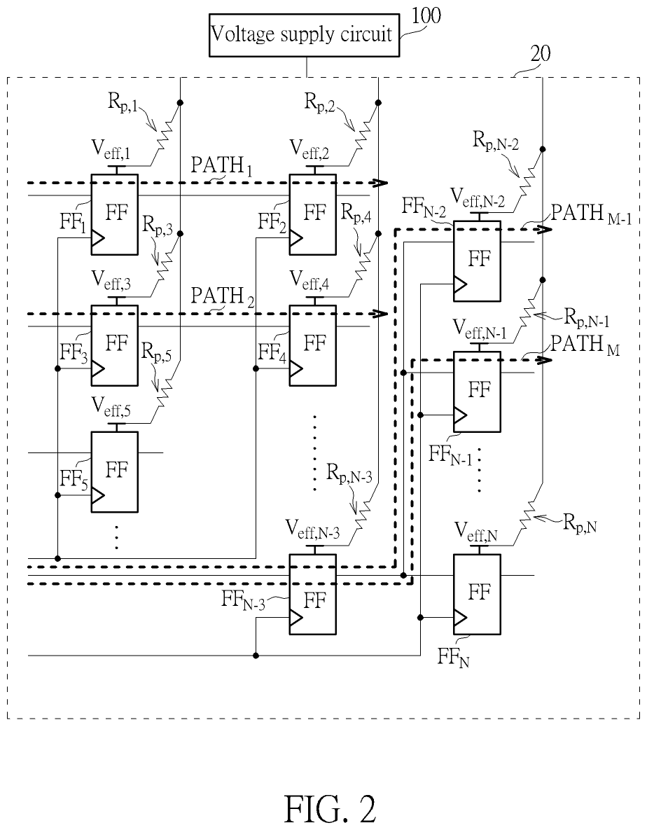

Embodiments of the present invention provide a method for adaptive voltage scaling to eliminate delay variation of a whole design (referred to as the method hereafter, for brevity) and associated apparatus such as an analyzing device (which may be referred to as the device, for brevity). Based on at least one of multiple control schemes of the method (e.g. the control schemes in some embodiments such as that shown in FIG. 1 and FIG. 2), the device can solve problems such as delay variation, and yield can be improved.

FIG. 1 is a diagram illustrating a whole design 10 and a voltage supply circuit 100 according to an embodiment of the present invention, wherein the whole design may represent an integrated circuit structure, but the present invention is not limited thereto. The whole design 10 may comprise multiple minimum units, which may be implemented by a network formed by flip-flops FF₁-FF_{N} such as flip-flops {FF₁, FF₂, FF₃, FF₄, FF₅, . . . , FF_{N-3}, FF_{N-2}, FF_{N-1}, FF_{N}} coupled to one another in this embodiment, where N is an integer greater than one. Each of the flip-flops FF₁-FF_{N} is coupled to the voltage supply circuit 100 that is capable of providing a driving voltage. This is for illustrative purposes only, and is not meant to be a limitation of the present invention. For example, each of the multiple minimum units may be replaced with any of other types of logic circuit units, and any two minimum units within the multiple minimum units may be different from each other.

In this embodiment, a circuit simulation netlist file may be generated according to the network, and indicate component information of the whole design 10 (e.g. respective input terminals and output terminals of each of the flip-flops FF₁-FF_{N}). In addition, a path list may indicate at least one portion (a portion or all) of path information of the whole design 10. For example, the path list may comprise at least one path of the whole design 10, such as a path PATH₁ passing through the flip-flops FF₁ and FF₂. In this embodiment, in addition to the path PATH₁ passing through the flip-flops FF₁ and FF₂, the path list may further comprise a path PATH₂ passing through the flip-flops FF₃ and FF₄, . . . , a path PATH_{M-1} passing through the flip-flops FF_{N-3} and FF_{N-2}, and a path PATH_{M} passing through the flip-flops FF_{N-3} and FF_{N-1} (M is a positive integer), but the present invention is not limited thereto.

In this embodiment, a delay variation database for each of the multiple minimum units (such as the flip-flops FF₁-FF_{N}) under various voltage levels may be built according to a circuit design database. For example, the circuit design database may comprise process information provided by the wafer fab, specification requirements, and resistor or capacitor information (which may be referred to as RC information) within the whole design 10, where the process information may comprise circuit characteristics and behaviors (for example, component characteristics such as process variation) of each minimum unit (such as each of the flip-flops FF₁-FF_{N}). In this embodiment, through a statistics method (e.g. Monte-Carlo method), the device (e.g. a processing circuit therein) may build the delay variation database (such as a mapping table) according to the process information. More particularly, for the aforementioned each minimum unit of the whole design 10, the device (e.g. the processing circuit) may determine delay variation of the aforementioned each minimum unit, such as the delay variation corresponding to a certain voltage level of the driving voltage, through the mapping table, but the present invention is not limited thereto.

Then, the device (e.g. the processing circuit) may utilize an initial voltage level to be a voltage level of a driving voltage provided by the voltage supply circuit 100 coupled to the whole design 10, to apply the initial voltage level to the whole design 10, and according to the aforementioned delay variation database, the device may perform static timing analysis (STA) on the whole design 10, to determine whether any timing violation path (e.g. at least one timing violation path, such as one or more timing violation paths) exists in the paths {PATH₁, PATH₂, . . . , PATH_{M-1}, PATH_{M}} within the path list. The path list includes combinational cells from Flip-Flop to Flip-Flop in PATH_{1 . . . M}, for example, each of the paths {PATH₁, PATH₂, . . . , PATH_{M-1}, PATH_{M}} includes combinational cells from Flip-Flop to Flip-Flop. The timing violation path may include, but are not limited to: a path having a delay that is not within in an allowable range of delay specification requirement.

For example, provided that the allowable range of delay specification requirement is set to be within +1 ns of the delay specification requirement (e.g. 1 ns), when a delay of the path PATH₁ is 1.06 ns (i.e. this delay corresponds to an error of +6%), the path PATH₁ may be regarded as a timing violation path. When a delay of the path PATH₁ is 0.94 ns (i.e. this delay corresponds to an error of −6%), the path PATH₁ may not be regarded as a timing violation path.

Additionally, according to whether the timing violation path exists, the device (e.g. the processing circuit) may selectively adjust the voltage level of the driving voltage and re-perform the STA until no timing violation path exists (e.g. the aforementioned at least one timing violation path no longer exists). For example, after the STA is performed for the first time, the timing violation path (e.g. the paths PATH₁ and PATH₂) exists in the path list, and then the voltage level of the driving voltage is adjusted to a second voltage level (e.g. 0.91 V) that is different from the initial voltage level (e.g. 0.9 V). After adjusting the voltage level of the driving voltage to the second voltage level (e.g. 0.91 V) and performing the STA for the second time, the device (e.g. the processing circuit) determines that the timing violation path has been removed, and the second voltage level (e.g. 0.91 V) may be utilized as a voltage level of an adaptive voltage conforming to the delay specification requirement of the whole design 10. For another example, after the STA is performed for the first time, the timing violation path (e.g. the path PATH₁ and PATH₂) exists in the path list, and then the voltage level of the driving voltage is adjusted to a second voltage level (e.g. 0.91 V) that is different from the initial voltage level (e.g. 0.9 V). After the STA is performed for the second time, the timing violation path (e.g. the path PATH₁) still exists in the path list, and then the voltage level of the driving voltage is adjusted to a third voltage level (e.g. 0.92 V) that is different from the initial voltage level (e.g. 0.9 V) and the second voltage level (e.g. 0.91 V). After adjusting the voltage level of the driving voltage to the third voltage level (e.g. 0.92 V) and performing the STA for the third time, the device (e.g. the processing circuit) determines that the timing violation path has been removed, and the third voltage level (e.g. 0.92 V) may be utilized as the voltage level of the adaptive voltage conforming to the delay specification requirement of the whole design 10. As shown in the above examples, when the timing violation path exists in the path list, the device (e.g. the processing circuit) may adjust the voltage level of the driving voltage and re-perform the STA, iteratively, until no timing violation path exists (e.g. the aforementioned at least one timing violation path no longer exists). For yet another example, after the STA is performed for the first time, when no timing violation path exists in the path list (e.g. the aforementioned at least one timing violation path no longer exists), the device (e.g. the processing circuit) may determine that the initial voltage level (e.g. 0.9 V) may be utilized as the voltage level of the adaptive voltage conforming to the delay specification requirement of the whole design 10, and more particularly, may prevent adjusting the voltage level of the driving voltage and prevent re-performing the STA, but the present invention is not limited thereto.

In addition, after the voltage level of the driving voltage conforming to the delay specification requirement of the whole design 10 (such as the voltage level of the aforementioned adaptive voltage) is found, the device (e.g. the processing circuit) may utilize a circuit simulator to perform verification, to guarantee correctness of the voltage level of the driving voltage (for example, a simulation result of the circuit simulator is identical or similar to an analysis result of the aforementioned STA, which may indicate that the voltage level of the driving voltage is correct), where the circuit simulator may be equipped with transistor-level simulation capability.

FIG. 2 is a diagram illustrating a whole design 20 and a voltage supply circuit 100 according to another embodiment of the present invention, where the whole design 20 may represent an integrated circuit structure, but the present invention is not limited thereto. The structure of the whole design 20 shown in FIG. 2 is based on the structure of the whole design 10 shown in FIG. 1. The main difference between the whole design 20 and the whole design 10 is that each of the flip-flops FF₁-FF_{N} is coupled to the voltage supply circuit 100 through a corresponding resistor (such as the corresponding one of the resistors {R_{p,1}, R_{p,2}, R_{p,3}, R_{p,4}, R_{p,5}, . . . , R_{p,N-3}, R_{p,N-2}, R_{p,N-1}, R_{p,N}} respectively coupled to the flip-flops {FF₁, FF₂, FF₃, FF₄, FF₅, . . . , FF_{N-3}, FF_{N-2}, FF_{N-1}, FF_{N}}), such that respective effective voltage levels (such as effective voltage levels {V_{eff,1}, V_{eff,2}, V_{eff,3}, V_{eff,4}, V_{eff,5}, . . . , V_{eff,N-3}, V_{eff,N-2}, V_{eff,N-1}, V_{eff,N}} respectively corresponding to the flip-flops {FF₁, FF₂, FF₃, FF₄, FF₅, . . . , FF_{N-3}, FF_{N-2}, FF_{N-1}, FF_{N}}) of the driving voltage for driving the flip-flops FF₁-FF_{N} are different from the voltage level provided by the voltage supply circuit 100 (for example, the effective voltage levels may be lower than the voltage level provided by the voltage supply circuit 100), where any of the respective effective voltage levels (e.g. the effective voltage level V_{eff,1}) for driving a minimum unit (e.g. the flip-flop FF₁) may be determined by a resistor (e.g. R_{p,1}) coupled to the minimum unit (e.g. the flip-flop FF₁), and a resistance of the resistor may be determined by the physical layout of the minimum unit (e.g. the flip-flop FF₁) in the whole design 20, but the present invention is not limited thereto. Similarly, the effective voltage level {V_{eff,2}, V_{eff,3}, V_{eff,4}, V_{eff,5}, . . . , V_{eff,N-3}, V_{eff,N-2}, V_{eff,N-1}, V_{eff,N}} may be determined according to the same way. For brevity, further details are omitted.

In this embodiment, according to the physical layout of the whole design 20 shown in FIG. 2, the device (e.g. the processing circuit) may generate current-resistance (IR) drop information of the whole design 20, and the IR drop information may comprise the effective voltage levels {V_{eff,1}, V_{eff,2}, V_{eff,3}, V_{eff,4}, V_{eff,5}, . . . , V_{eff,N-3}, V_{eff,N-2}, V_{eff,N-1}, V_{eff,N}} respectively corresponding to the flip-flops {FF₁, FF₂, FF₃, FF₄, FF₅, . . . , FF_{N-3}, FF_{N-2}, FF_{N-1}, FF_{N}} mentioned above. For a certain minimum unit within the multiple minimum units, the device (e.g. the processing circuit) may determine an effective voltage level applied to the certain minimum unit according to the IR drop information, and determine delay variation corresponding to the certain minimum unit according to the effective voltage level. For example, when the voltage supply circuit 100 provides a voltage level (e.g. 1 V), the device (e.g. the processing circuit) may determine a effective voltage level (e.g. 0.95 V) for driving the flip-flop FF₁ according to the IR drop information, and determine delay variation of the flip-flop FF₁ operating under the effective voltage level according to the delay variation database for subsequent steps (such as the aforementioned STA and adaptive voltage scaling). For brevity, similar descriptions for this embodiment are not repeated in detail here.

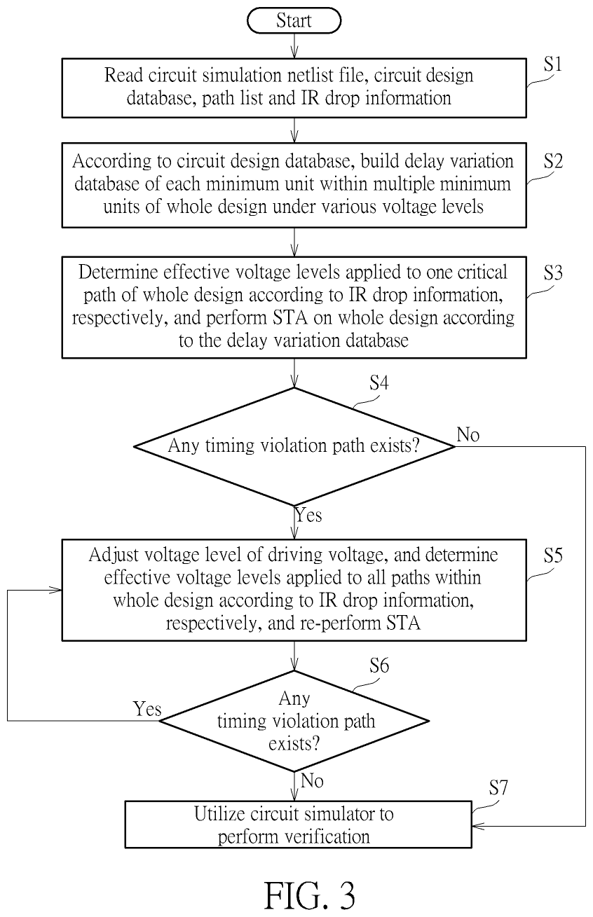

FIG. 3 is a workflow of the method according to an embodiment of the present invention. For illustrative purposes, the workflow shown in FIG. 3 is described by referring to the whole design 20 shown in FIG. 2, but the present invention is not limited thereto. Through the workflow shown in FIG. 3, the method may be summarized as follows.

Step S1: the device (e.g. the processing circuit) may read a circuit simulation netlist file, a circuit design database, a path list and IR drop information.

Step S2: according to the circuit design database, the device (e.g. the processing circuit) may build a delay variation database of each minimum unit within multiple minimum units (such as the Process Device (e.g. devices or component for a specific process)) of the whole design 20 under various voltage levels.

Step S3: the device (e.g. the processing circuit) may utilize an initial voltage level (e.g. 1 V) to be a voltage level of a driving voltage of the whole design 20, and determine effective voltage levels applied to the one critical path such as the critical one of the paths {PATH₁, PATH₂, . . . , PATH_{M-1}, PATH_{M}} (e.g. effective voltage levels equal to 0.95 V for a critical path case from FF₁ to FF₂ (such as minimum units within the PATH₁)) of the whole design 20 according to the IR drop information, respectively, to apply the effective voltage levels to the one critical path within the whole design 20, respectively, and perform the STA on the whole design 20 to generate an analysis result according to the delay variation database.

Step S4: according to the analysis result in Step S3, the device (e.g. the processing circuit) may determine whether any timing violation path (e.g. at least one timing violation path such as that mentioned above) exists in the path list. When the timing violation path (e.g. the paths PATH₁ and PATH₂) exists in the path list, Step S5 is entered; otherwise, Step S7 is entered.

Step S5: the device (e.g. the processing circuit) may adjust the voltage level of the driving voltage to another voltage level (e.g. 1.01 V), and determine the effective voltage levels applied to all paths (e.g. 0.96 V for all paths {PATH₁, PATH₂, . . . , PATH_{M-1}, PATH_{M}} (such as all minimum units within the paths {PATH₁, PATH₂, . . . , PATH_{M-1}, PATH_{M}}, or respective effective voltage levels for different paths)) within the whole design 20 according to the IR drop information, respectively, to apply the effective voltage levels to the all paths within the whole design 20, respectively, and re-perform the STA to generate an analysis result.

Step S6: according to the analysis result in Step S5, the device (e.g. the processing circuit) may determine whether any timing violation path (e.g. at least one timing violation path such as that mentioned above) exists in the path list. When the timing violation path (e.g. the paths PATH₁) exists in the path list, Step S5 is entered; otherwise, Step S7 is entered.

Step S7: the device (e.g. the processing circuit) may utilize a circuit simulator to perform verification, to guarantee correctness of the voltage level of the driving voltage, wherein the circuit simulator is equipped with transistor-level simulation capability.

Please note that, as long as it does not hinder the implementation of the present invention, one or more steps may be altered, added, or deleted in the workflow. After reading the above paragraphs regarding FIG. 1 and FIG. 2, those skilled in the art should be able to understand the operations of each step shown in FIG. 3. For brevity, related details are omitted.

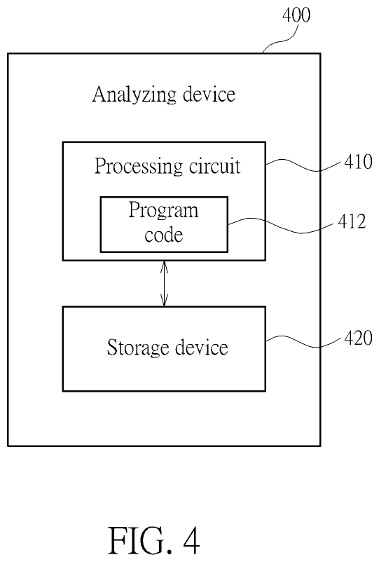

FIG. 4 is a diagram illustrating an analyzing device 400 according to an embodiment of the present invention, where the analyzing device 400 may be an example of the device. In this embodiment, the method (e.g. the workflow shown in FIG. 3) may be utilized on the analyzing device 400. The analyzing device 400 may comprise a processing circuit 410 (which may comprise at least one processor, memory, chipset, bus, and so on) and at least one storage device such as storage device 420 (e.g. one or more hard disk drives (HDDs) and/or one or more solid-state drives (SSDs)). More particularly, the processing circuit 410 may be arranged to execute a set of program codes 412 corresponding to the method, to control the analyzing device 400 to operate according to the method (e.g. the workflow shown in FIG. 3), where the set of program codes 412 may be implemented as an application program, and the storage device 420 may store the circuit simulation netlist file, the circuit design database, the path list and the IR drop information read by the analyzing device 400 in Step S1, and store the delay variation database built by the analyzing device 400 in Step S2 for subsequent analysis, but the present invention is not limited thereto. Examples of the analyzing device 400 may include, but are not limited to: a personal computer and a server.

Through the adaptive voltage scaling and timing path analysis mechanisms of the present invention, in comparison with conventional design method and corner analysis method, the method and apparatus of the present invention can precisely determine the delay variation of a whole design (i.e. the delay variation of signal paths within the whole design), and quickly eliminate the delay variation of the whole design by adaptive voltage scaling without using other way such as amending circuit structure, and therefore can prevent any side effect (e.g. additional risks and costs) due to the other way such as amending circuit structure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adaptive voltage scaling to eliminate delay variation of a whole design, comprising:
reading a circuit simulation netlist file, a circuit design database, and a path list, wherein the circuit simulation netlist file indicates component information of the whole design;
according to the circuit design database, building a delay variation database of each minimum unit within multiple minimum units of the whole design under various voltage levels;
utilizing an initial voltage level to be a voltage level of a driving voltage of the whole design to apply the initial voltage level to the whole design, and according to the delay variation database, performing static timing analysis (STA) on the whole design, to determine whether any timing violation path exists in the path list; and
according to whether the timing violation path exists, selectively adjusting the voltage level of the driving voltage and re-performing the STA until no timing violation path exists.

2. The method of claim 1, wherein the step of selectively adjusting the voltage level of the driving voltage and re-performing the STA until no timing violation path exists further comprises:
when the timing violation path exists in the path list, adjusting the voltage level of the driving voltage to another voltage level that is different from the initial voltage level, and re-performing the STA to determine whether the timing violation path is removed; otherwise, preventing adjusting the voltage level of the driving voltage and preventing re-performing the STA.

3. The method of claim 1, wherein the step of selectively adjusting the voltage level of the driving voltage and re-performing the STA until no timing violation path exists further comprises:
when the timing violation path exists in the path list, adjusting the voltage level of the driving voltage and re-performing the STA, iteratively, until no timing violation path exists.

4. The method of claim 1, further comprising:
utilizing a circuit simulator to perform verification, to guarantee correctness of the voltage level of the driving voltage, wherein the circuit simulator is equipped with transistor-level simulation capability.

5. The method of claim 1, wherein the circuit design database comprises circuit characteristics and behaviors of said each minimum unit, specification requirements, and resistor or capacitor information within the whole design.

6. The method of claim 1, wherein the path list comprises at least one path within the whole design.

7. The method of claim 1, further comprising:
determining an effective operating voltage level applied to a certain minimum unit within the multiple minimum units according to current-resistance (IR) drop information, and determining delay variation corresponding to the certain minimum unit according to the effective operating voltage level.

8. The method of claim 1, wherein the whole design represents an integrated circuit structure.

9. An analyzing device, comprising:
a processing circuit, arranged to control the analyzing device to perform the following operations:
reading a circuit simulation netlist file, a circuit design database, and a path list, wherein the circuit simulation netlist file indicates component information of the whole design;
according to the circuit design database, building a delay variation database of each minimum unit within multiple minimum units of the whole design under various voltage levels;
utilizing an initial voltage level to be a voltage level of a driving voltage of the whole design to apply the initial voltage level to the whole design, and
according to the delay variation database, performing static timing analysis (STA) on the whole design, to determine whether any timing violation path exists in the path list; and
according to whether the timing violation path exists, selectively adjusting the voltage level of the driving voltage and re-performing the STA until no timing violation path exists.

10. The analyzing device of claim 9, wherein when the timing violation path exists in the path list, the analyzing device adjusts the voltage level of the driving voltage to another voltage level that is different from the initial voltage level, and re-performs the STA to determine whether the timing violation path is removed; otherwise, the analyzing device prevents adjusting the voltage level of the driving voltage and prevents re-performing the STA.

11. The analyzing device of claim 9, wherein when the timing violation path exists in the path list, the analyzing device adjusts the voltage level of the driving voltage and re-performs the STA, iteratively, until no timing violation path exists.

12. The analyzing device of claim 9, wherein the analyzing device utilizes a circuit simulator to perform verification, to guarantee correctness of the voltage level of the driving voltage, wherein the circuit simulator is equipped with transistor-level simulation capability.

13. The analyzing device of claim 9, wherein the circuit design database comprises circuit characteristics and behaviors of said each minimum unit, specification requirements, and resistor or capacitor information within the whole design.

14. The analyzing device of claim 9, wherein the path list comprises at least one path within the whole design.

15. The analyzing device of claim 9, wherein the analyzing device determines an effective operating voltage level applied to said each minimum unit according to current-resistance (IR) drop information, and the analyzing device determines delay variation corresponding to said each minimum unit according to the effective operating voltage level.

16. The analyzing device of claim 9, wherein the whole design represents an integrated circuit structure.
